(19) United States
(12) Patent Application Publication
(10) Pub. No.: US 2015/0095281 A1
(43) Pub. Date: Apr. 2, 2015

(54) METHOD AND APPARATUS FOR ADJUSTING THE FREQUENCY OF CONTENT UPDATES

(71) Applicant: Nokia Corporation, Espoo (FI)

(72) Inventors: Lassi Taneli NIEMINEN, Helsinki (FI); Ari Olavi TOURUNEN, Espoo (FI)

(73) Assignee: Nokia Corporation, Espoo (FI)

(21) Appl. No.: 14/041,980

(22) Filed: Sep. 30, 2013

(51) Int. Cl. G06F 17/30

(52) U.S. Cl. CPC G06F 17/30377
USPC 707/618

(57) ABSTRACT

An approach is provided for causing, at least in part, an initiation of at least one content update request based, at least in part, on a first update frequency. The update frequency platform may determine at least one result of the at least one content update request. Then, the update frequency platform may cause, at least in part, an adjustment of the first update frequency to a second update frequency based, at least in part, on the at least one result.

### BACKGROUND

Service providers and device manufacturers (e.g., wireless, cellular, etc.) are continually challenged to deliver value and convenience to consumers by, for example, providing compelling network services. One area of interest has been the development of sharing content and communication via emails, applications, social networks. The content may take the form of updates or include updates, all of which may be of interest to a particular user. For example, users often share content items via social networks and enjoy observing whether the content items are well-received and/or interesting to other users, for instance, users within a social network. Some users update often, while other users update infrequently. Devices, services, and/or applications are often set to present content at set times. For instance, update cycles may be 15 minutes or 30 minutes where updates are collected and then presented in one installment at each of these time intervals. The updates occur based on the time interval, whether the updates are few or many and whether or not the updates are meaningful to a specific user. Therefore, content providers face challenges in offering content updates that are relevant to users, both in timing and in substance.

### SOME EXAMPLE EMBODIMENTS

Therefore, there is a need for an approach for adjusting the frequency at which a user receives updates.

According to one embodiment, a method comprises causing, at least in part, an initiation of at least one content update request based, at least in part, on a first update frequency. The method also comprises determining at least one result of the at least one content update request. The method further comprises causing, at least in part, an adjustment of the first update frequency to a second update frequency based, at least in part, on the at least one result.

According to another embodiment, an apparatus comprises at least one processor, and at least one memory including computer program code for one or more computer programs, the at least one memory and the computer program code configured to, with the at least one processor, cause, at least in part, the apparatus to cause, at least in part, an initiation of at least one content update request based, at least in part, on a first update frequency. The apparatus is also caused to determine at least one result of the at least one content update request. The apparatus is further caused to cause, at least in part, an adjustment of the first update frequency to a second update frequency based, at least in part, on the at least one result.

According to another embodiment, a computer-readable storage medium carries one or more sequences of one or more instructions which, when executed by one or more processors, cause, at least in part, an apparatus to cause, at least in part, an initiation of at least one content update request based, at least in part, on a first update frequency. The apparatus is also caused to cause, at least in part, an initiation of at least one content update request based, at least in part, on a first update frequency. The apparatus is further caused to cause, at least in part, an adjustment of the first update frequency to a second update frequency based, at least in part, on the at least one result.

According to another embodiment, an apparatus comprises means for causing, at least in part, an initiation of at least one content update request based, at least in part, on a first update frequency. The apparatus also comprises means for determining at least one result of the at least one content update request. The apparatus further comprises means for causing, at least in part, an adjustment of the first update frequency to a second update frequency based, at least in part, on the at least one result.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of adjusting the frequency at which a user receives updates, according to one embodiment;

FIG. 2A is a diagram of the components of an update frequency platform, according to one embodiment;

FIG. 2B is a diagram of the components of the frequency module within the update frequency platform, according to one embodiment;

FIG. 3 is a flowchart of a process for adjusting the frequency at which a user receives updates, according to one embodiment;

FIG. 4 is a flowchart of a process for determining a second update frequency, according to one embodiment;

FIG. 5 is a flowchart of a process for determining measures of user interest, according to one embodiment;

FIG. 6 is a flowchart of a process for determining parameters specific to sources of updated content items;

FIG. 7 shows a signal diagram of the process of FIG. 3, according to one embodiment;

FIG. 8 shows a flowchart of a process for adjusting the update frequency, according to one embodiment;

FIGS. 9A-9D are diagrams of user interfaces utilized in the processes of FIG. 3, according to various embodiments;

FIG. 10 is a diagram of hardware that can be used to implement an embodiment of the invention;

FIG. 11 is a diagram of a chip set that can be used to implement an embodiment of the invention; and

FIG. 12 is a diagram of a mobile terminal (e.g., handset) that can be used to implement an embodiment of the invention.

### DESCRIPTION OF SOME EMBODIMENTS

Examples of a method, apparatus, and computer program for adjusting the frequency at which a user receives updates are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

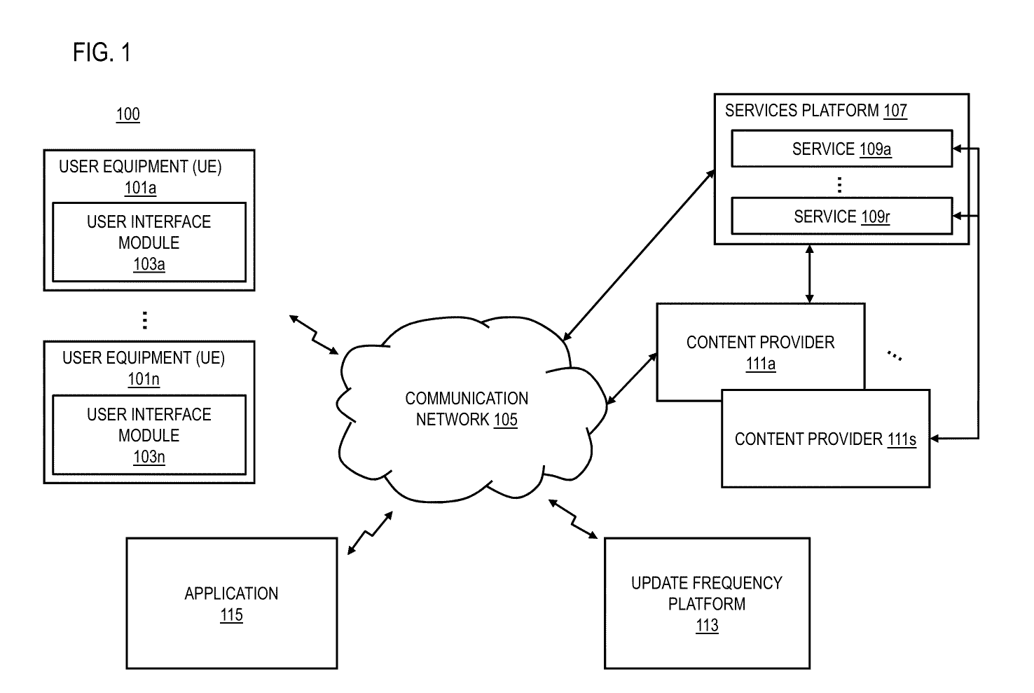

FIG. 1 is a diagram of a system capable of adjusting the frequency at which a user receives updates, according to one embodiment. Service providers and device manufacturers (e.g., wireless, cellular, etc.) are continually challenged to deliver value and convenience to consumers by, for example, providing compelling network services. One area of interest has been the development of sharing content and communication via emails, applications, social networks. One aspect of this area, is also understanding the interest created around shared content. Sharing content and evaluating the popularity of shared content may take the form of updates. For example, users often share content items via social networks and enjoy observing whether the content items are well-received and/or interesting to other users, for instance, whether other users within a social network re-post, comment, or in some way interact with the content items. New shared content and interaction of users with content items may take the form of updates.

Devices, services, and applications are often set to present updates (including new content items and/or reactions to previously shared content items) at set times. For instance, update cycles may be 15 minutes or 30 minutes. This means updates may be stored on a network server, then presented in one installment at each of these time intervals. The updates occur based on the time interval, whether the updates are few or many and whether or not the updates are meaningful to a specific user. Therefore, content providers face challenges in offering content updates that are relevant to users, both in timing and in substance.

To address this problem, a system 100 of FIG. 1 introduces the capability to adjust the frequency at which a user receives updates, according to one embodiment. For example, the system 100 may manage updates to be presented to a user only where there is something meaningful to update. In one embodiment, the system 100 may determine updates meaningful to a particular user. Something meaningful to update to a user may include when another user contacts that user via a social network or when the user's shared content is re-posted. In another embodiment, a meaningful update may include updates to webpages, video blogs, e-books, video channels, etc. Then, the system 100 may adjust update frequency to present users with meaningful updates, rather than at time intervals that are not tailored to content substance or how often content is available. In doing so, the system 100 may help facilitate data usage and costs to reflect the usage and interest of particular users.

In one embodiment, the system 100 may set an initial time interval, “N.” Then, the system 100 may determine devices associated with various networks and social targets. Social targets may include any services associated with a user, for instance, applications, emails, subscriptions, social networks, etc. The system 100 may then gather information from the targets to compute information that may be meaningful for users (or a particular user). For instance, a weather application with a collection of meteorological measurements may contain information regarding temperature, humidity, likelihood of precipitation, future forecasts, etc. The system 100 may determine that temperature and likelihood of precipitation information is most meaningful to users out of the collection of measurements. In one embodiment, the system 100 may take into account previous activity information and user social interest models to compute what is meaningful to users. Previous activity information may include, for instance, information on how an application is commonly used. For instance with the weather application, the system 100 may find that temperature and precipitation are the most frequently retrieved pieces of information. User social interest models may include, for instance, determining user demographics for the social targets and inferring interests of users within that demographic. Furthermore, the system 100 may incorporate understandings of users associated with specific accounts and/or devices in determining what is meaningful to the user. For instance, the system 100 may determine characteristics of a user based on his/her accounts and/or devices, including location information, age, occupation, hobbies, etc. Individual user information may further help system 100 tailor updates to users, based on what is personally relevant to individual users.

In one embodiment, the system 100 may determine updated content items present within the various networks and social targets. Then, the system 100 may determine if the updated content items correspond to content that is meaningful to users. If there is no meaningful data, the system 100 may adjust to time interval N to a new interval “O.” In one embodiment, the system 100 may adjust time interval N such that O>N, meaning updates occur less frequently (since there are no meaningful updates). On the other hand, observance of meaningful data may cause system 100 to adjust time interval N to a new interval “M.” For instance, system 100 may make the adjustment such that M<N, thus making the updates happen less frequently.

In one embodiment, system 100 may adjust a time interval N or update frequency after each detection of updated content items at social targets associated with devices such that the system 100 adapts update frequencies to be optimal for a user, given his interests. In other words, a user should receive updates meaningful to him as soon as possible, but not be disturbed with irrelevant updates in between. In one embodiment, the system 100 may further recognize future meaningful updates and use them to trigger additional updates. For example, the system 100 may recognize that a user has shared content (e.g. posting a picture to a social network). The user likely wishes to keep track of whether other users are responsive to the shared content. The shared content may generate reactions from other users (and trigger additional updates (e.g. informing the user posting the content that other users are interacting with the content)). In this case, the system 100 may determine the shared content and continue to monitor the content for updates related to the content.

In one embodiment, users may configure system 100 to allow finer degrees of timing between multiple services. For example, system 100 may permit several layers or contexts for meaningful information. For instance, what is meaningful in one social network might not be meaningful to a user in another social network. For example, system 100 may permit a user to configure or enter their interests, specific to each social network they are associated with. One such scenario may include a user on three social networks. On the first social network, the user may only be interested in content items from contacts defined as “family.” On the second social network, the user may only find content items related to the topic, “food,” of interest, regardless of who the content item is from. On the third social network, a user may only want to know about content items that are in a specific range of context information. For instance, a user may only want to know about content items that include information that occurs within a 3 mile radius from him. System 100 may use these various settings to determine what constitutes meaningful content to a user in determining when to present updates to a user.

In another embodiment, the system 100 may determine repetition in content. For instance, the system 100 may employ key word or image recognition to determine where multiple content items contain very similar or almost identical content. In one instance, the system 100 may then choose only the latest content item out of multiple similar content items to present to a user. In one embodiment, the system 100 may also take into account content information associated with a device. For instance, if a device is detected to be at a user's office, the system 100 may determine that update frequency cannot exceed a certain timing since a user may not want to be continually disturbed at work. In another instance, a device may detect that a user will be in an area with little reception, and so, display updated content prior to the update frequency would otherwise dictate so a user may see the latest updated content items before losing service. In one case, the system 100 may rely on users to create settings for different locations, for instance, and/or scenarios where they may want more frequent or less frequent update frequencies. In another scenario, the system 100 may determine the extent to which context information may affect update frequencies based on observations of a user's behavior. In such a case, if a user frequently checks updates in the evenings, the system 100 may determine that update frequencies may be as frequent as necessary. On the other hand, if a user never checks updates in the evenings, the system 100 may determine that update frequencies may be lower. In yet another instance, the system 100 may synchronize with other services, for example, a calendar service, to determine update frequencies. For example, the system 100 may know from a calendar service when a user is on vacation, in a meeting, on a date, etc., and adjust update frequencies accordingly.

In a further embodiment, the system 100 may determine user interactions with updated content items to determine user interest in adjusting frequencies for meaningful content. For example, user interactions may include users clicking on updated content items, re-posting updated content items, commenting, or “like”-ing updated content items. In observing what content items users respond to, the system 100 may continually refine its understanding of what constitutes meaningful content to a user.

In one embodiment, the system 100 may include an override function for a user to manually select to view updates prior to the completion of a time interval between updates. For instance, the system 100 may present a graphical representation of the time interval. For instance, the graphical representation may simply show the amount of time in the update frequency, or the graphical representation may include a countdown and/or progress bar. Then, the user may opt to view updates before the time interval between updates has completely run. In one embodiment, the system 100 may also include content that overrides the update frequency. For instance, the system 100 may change update frequencies such that when any meaningful content items are determined, the content items are presented to users. Alternately, the system 100 may change update frequencies such that a threshold number of meaningful content item updates are collected before they are shown to users. In the latter instance, the system 100 may include some categories of content item updates that may cause updates to be presented, even if the threshold number has not been reached.

As shown in FIG. 1, the system 100 comprises a user equipment (UE) 101a-101n (or UEs 101) having connectivity to user interface modules 103a-103n (or user interface modules 103), services platform 107, service 109a-109r, content provider 111a-111s, an update frequency platform 113, and an application 115 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, the user interface modules 103 may provide a means for users to configure update frequencies. For instance, the user interface modules 103 may prompt users to enter threshold frequencies and/or interests, both in general and with regards to specific services and/or applications. For instance, user interface modules 103 may present users with menu items regarding their settings per application and service at which service 100 detects a user account. User interface modules 103 may also keep track of how a user interacts with updates they receive. For instance, on content with which users interact with more, user interface modules 103 may note the interaction and later inform the update frequency platform 113 so that the update frequency platform 113 may form inferences regarding user interest. In another embodiment, the user interface modules 103 may present users with one or more graphical representations with which users may override update frequencies. For instance, user interface modules 103 may show countdowns or progress bars showing the time remaining before the next update. In such an instance, the user interface modules 103 may also communicate with the update frequency platform 113 if user interactions prompt direct changes to update frequencies. In one scenario, system 100 may form update frequencies such that update frequencies are adjusted with consideration to users' manual overrides.

The UEs 101 are also connected to a services platform 107 via the communication network 105. In one embodiment, the services platform 107 includes one or more services 109a-109r (also collectively referred to as services 109). The services 109 may include a wide variety of services such as content provisioning services for the application 115. By way of example, the services 109 may include social networking services, video or media services, advertising and discount services, etc. In one embodiment, the UEs 101, the services platform 107, and the services 109 also have connectivity to one or more content providers 111a-111s (also collectively referred as content providers 111). The content providers 111 also may provision a wide variety of content (e.g., communications via social networks, new content on webpages, additions to e-books, newly uploaded videos on video channels, etc.) to the components of the system 100.

In one embodiment, the update frequency platform 113 may evaluate user interests. For instance, the update frequency platform 113 may determine updated content and/or updated content items and determine whether a user is interested in the content items. From there, the update frequency platform 113 may determine whether that content is interesting to a particular user. In one embodiment, the update frequency platform 113 may first, determine various ways to gauge user interest. Measures of user interest may include determining whether a user has interacted with content, what other users of a service or application appear to be interested in, a user's context information, and/or information that a user has entered himself.

In one embodiment, the update frequency platform 113 may further whether an adjustment to update frequency is necessary, and if so, what the adjustment should be. For instance, the update frequency platform 113 may determine that content meaningful to a user exists. The update frequency platform 113 may then determine whether to adjust update frequency immediately and present the content immediately, or whether to collect a threshold amount of content prior to presenting the content and/or adjusting update frequency. In another instance, the update frequency platform 113 may also determine how much to adjust the update frequency. For instance, the update frequency platform 113 may adjust the update frequency such that meaningful content is presented each time it is available. In another instance, the update frequency platform 113 may determine that update frequency cannot be higher than a certain timing. For instance, people may not wish to be disturbed or devices may not have the capacity to update past a certain update frequency.

In one embodiment, the application 115 may serve as the means by which the UEs 101, services platform 107, content providers 111, and update frequency platform 113 interact. For example, the application 115 may determine when UEs 101 are in communication via services 109 at the services platform 107. For instance, two UEs 101 may be in communication via a social network that is one of the services 109. Then, the application 115 may make a request to the services 109 and content providers 111 associated with the services 109, for content from the communication. Upon receiving the content, the application 115 may determine when UEs 101 are interacting with each other via other applications, networks, and/or services, and prompt the update frequency platform 113 to evaluate whether the interaction constitutes an update (and a meaningful update). If the interaction includes meaningful update(s), the application 115 may prompt the update frequency platform 113 to adjust update frequencies based on the interactions.

By way of example, the UE 101, user interface modules 103, services platform 107, services 109, content providers 111, update frequency platform 113, and application 115 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

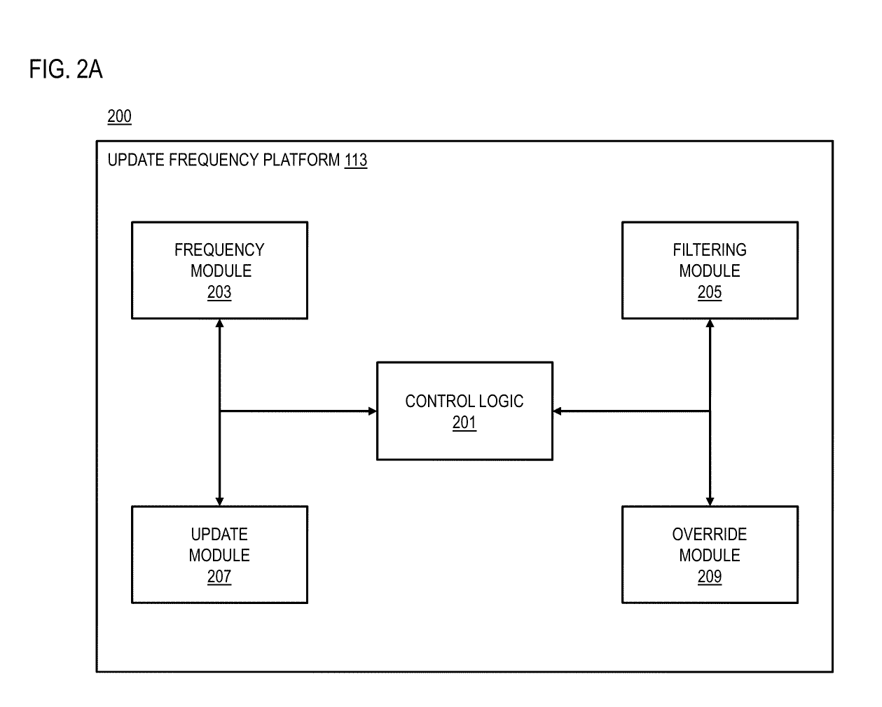

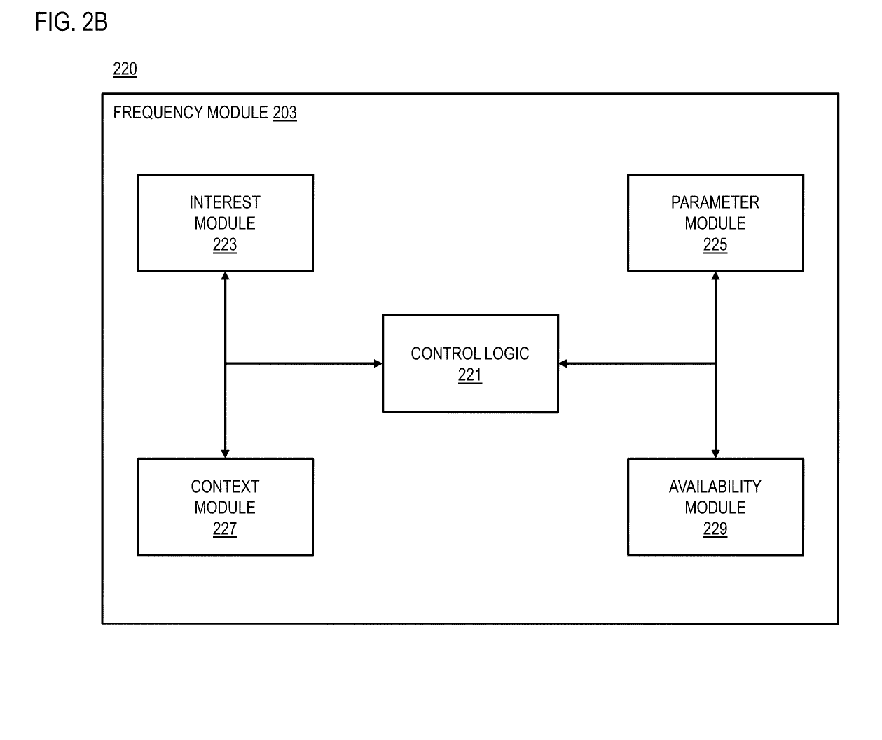

FIG. 2A is a diagram 200 of the components of the update frequency platform 113, according to one embodiment. By way of example, the update frequency platform 113 includes one or more components for providing determining the frequency at which a user receives updates. It is contemplated that the functions of these components may be combined in one or more components or performed by other components of equivalent functionality. In this embodiment, the update frequency platform 113 includes a control logic 201, a frequency module 203, a filtering module 205, an update module 207, and an override module 209.

In one embodiment, the control logic 201 and frequency module 203 may set an initial, first update frequency. For instance, the control logic 201 and frequency module 203 may determine default update frequencies for various applications, services, user accounts, etc. In one case, the control logic 201 and frequency module 203 may base default update frequencies for the applications, services, and/or user accounts on observed preferences or settings of existing or previous users. In another instance, the control logic 201 and frequency module 203 may set the first update frequency based on a particular user's behavior. For instance, if a user likes to refresh his screen often, the control logic 201 and frequency module 203 may set a high update frequency initially. Where a user barely interacts with a device connected with his applications, services, and accounts, the control logic 201 and frequency module 203 may apply a lower frequency. In choosing the first update frequency wisely, the control logic 201 and frequency module 203 may accelerate the timing of reaching an update frequency that is suitable for a user.

In one embodiment, the control logic 201 and filtering module 205 may determine, from a set of updated content data, a prioritization of updated content items. In an instance described above, the update frequency platform 113 may determine what updated content items may have the substance to signal that content update is available. In one embodiment, the control logic 201 and filtering module 205 may take the updated content items determined by the update frequency platform 113 to be meaningful, and prioritize and/or group the updated content items. In one instance, the control logic 201 and filtering module 205 may then use the prioritization and/or grouping in presenting the updated content items so that updated content items may be presented in an organized fashion. In another instance, the control logic 201 and filtering module 205 may use the prioritization and/or grouping to eliminate repetition. For instance, if one updated content item renders another updated content item moot, the control logic 201 and filtering module 205 may elect to take out the moot updated content item when updated content items are presented. For instance, one updated content item may indicate that 7 friends have “liked” a photograph uploaded by a user to a social network. A couple seconds later, another updated content item may indicate that 4 more friends have “liked” the photograph (for a total of 11 “likes” on the photograph). The user may simply need to see that 11 friends have “liked” the photograph. The control logic 201 and filtering module 205 may then take out the “7 friends” updated content item since it is repetitive with the “11 likes” updated content item.

In one embodiment, the control logic 201 and update module 207 may find the second update frequency. For instance, the control logic 201 and update module 207 may determine the amount of adjustment to the first update frequency. In one embodiment, the control logic 201 and update module 207 may determine whether to adjust the first update frequency based on a result or more than one result. For instance, the control logic 201 and update module 207 may determine that a result is available, at which point, the control logic 201 and update module 207 may typically decrease the time intervals between updates in order to reflect the first result. However, the control logic 201 and update module 207 may then also take into account other factors from the update frequency platform 113 and determine to consider those factors in adjusting the first update frequency. For instance, the update frequency platform 113 may indicate that a user is in a meeting. In this situation, the control logic 201 and update module 207 may determine to wait for two or three results before adjusting the update frequency since the control logic 201 and update module 207 may infer that the user may not want to be disturbed frequently during the meeting. Alternately, the control logic 201 and update module 207 may make the adjustments, not only by its own inferences, but also by user configuration. For example, a user may enter a setting where updates are not to occur more frequently than every 5 minutes. In this case, the control logic 201 and update module 207 may create the adjustment taking into account the results, as well as the user setting.

In one embodiment, the control logic 201 and override module 209 may cause a presentation of a graphical representation of update frequencies. For instance, the control logic 201 and override module 209 may communicate with the UEs 101 to present the graphical representation and determine user interaction with the graphical representation. For instance, a user may override the usual update frequency and select to view updated content items prior to the timing that updated content items would be presented according to the update frequency. For instance, an update frequency may be 5 minutes, meaning updated content items are compiled into a list and presented every 5 minutes. 2 minutes after the most recent presentation of updated content items, the control logic 201, override module 209, and user interface modules 103 may determine user interaction with the graphical representation of the 5 minute update frequency, where the control logic 201 and override module 209 then prompts a presentation of updated content items collected up to the 2 minutes, without waiting for the 5 minutes. In one embodiment, the control logic 201 and override module 209 may allow user override to interrupt the update frequency. For instance, in the previous example, the control logic 201 and override module 209 may still present updated content items at the usual 5 minutes, 3 minutes after the override at the 2-minute mark. In another instance, the control logic 201 and override module 209 may continue from the latest presentation. For instance with the previous example, the control logic 201 and override module 209 would then next present updated content items 5 minutes after the presentation at 2 minutes.

FIG. 2B is a diagram 220 of the components of the frequency module 203 of the update frequency platform 113, according to one embodiment. By way of example, the frequency module 203 includes one or more components for providing determining the frequency at which a user receives updates. It is contemplated that the functions of these components may be combined in one or more components or performed by other components of equivalent functionality. In this embodiment, the frequency module 203 includes a control logic 221, an interest module 223, a parameter module 225, a context module 227, and an availability module 229.

In one embodiment, the control logic 221 and interest module 223 may determine measures of user interest for whether updated content items will be interesting to a user. For instance, some content item updates might be more relevant to a particular user than others. For example, user A may be more interested in updates regarding her family and her closest friends, than updates for her acquaintances. In another example, user A may be particularly interested in updates for a particular news topic while other news topics are irrelevant to her. In yet another example, user A may wish to receive updates for video channels to which she has video subscriptions. In one embodiment, the control logic 221 and interest module 223 may determine updated content items within a result set and process the updated content items to determine measures of user interest associated with the updated content items. For example, the control logic 221 and interest module 223 may determine that within a result, updated content items include one news item related to healthcare policies, one friend's check-in at a local restaurant, and three relationship updates for a user's friends showing that the friends are engaged, married, or dating.

The control logic 221 and interest module 223 may gauge user interest by seeing, for instance, the frequency of the updates, how closely the updates match the user's own updates or profile, whether a user interacts with the updates, how frequently users similar to the user interact with the updates, etc. For instance, frequency of the updates may indicate user interest in that frequent updates on a particular topic may show that the topic is of interest, people want to note developments on the topic as it unfolds. How closely the updates match the user's own may show user interest, for example, users may be interested in updates that are related to events in their own lives. For instance, a user applying for graduate school may be interested in who else in her social network is in the application process or recently took an exam for an application process. User interaction with the updates may serve as a measure of interest for the control logic 221 and interest module 223 in that a user clicking on an update to read more details may show that that update is of interest to the user. Interactions of users similar to the user may further inform the control logic 221 and interest module 223 serve as another set of possible indicators of user interest.

In one embodiment after determining measures of interest, the control logic 221 and interest module 223 may further compile an understanding of what the interests are. For example, the control logic 221 and interest module 223 may determine that a particular user's interests include technological updates, check-ins at restaurants, and birthdays. In one embodiment, the control logic 221 and interest module 223 may construct a dynamic profile of a user's interests regarding updates, meaning what types of interests might be most interesting and/or relevant to a user.

In one embodiment, the control logic 221 and parameter module 225 may determine parameters regarding the substance of updated content items. For instance, parameters may include the topics of the substance, the people related to the substance, contextual information related to the content items, or a combination thereof. In one embodiment, users may select parameters based on topics, groups of people, and/or contextual information that is meaningful to them. For instance, users may select a “friends” parameter out of a range of parameters denoting relationships to a user, for example, “family”, “friends”, “close friends”, and “acquaintances.” In one embodiment, users may select various parameters specific to various user accounts, applications, services, or a combination thereof. For instance on a gaming application, the control logic 221 and parameter module 225 may find a user's setting to be on the “friends” setting for meaningful updates while the user's setting might be set to “family” for the user's account on a calendar application. In such a scenario, the control logic 221 and parameter module 225 may infer that updated content items that are meaningful to the user comprise of updates from “friends” connected from the gaming application and updates from “family” on the calendar application.

In one embodiment, the control logic 221 and context module 227 may determine sensor information associated with user devices. For example, the sensor information may include contextual information. For instance, the contextual information may include location information. In one embodiment, the control logic 221 and context module 227 may further determine factors that may affect adjustments to update frequencies. For instance, the control logic 221 and context module 227 may determine that a user is at his office. In this case, the update frequencies may be set to a lower frequency than when the user is on his leisure time since the user may not want to be interrupted often while at work. Then, the control logic 221 and context module 227 may base the update frequency on location or context information related to a device.

In one embodiment, the control logic 221 and availability module 229 may determine whether at least one result is available. In other words, the control logic 221 and availability module 229 may determine whether one or more updated content items have occurred. In one embodiment, the control logic 221 and availability module 229 may determine that at least one result is available when the control logic 221 and availability module 229 notes the existence of any updated content item. In another embodiment, the control logic 221 and availability module 229 may only determine that at least result is available where detected updated content items fall into interest, parameter, and/or context criterion associated with a particular user. For instance, where user interest is only in updated content items regarding friends on social network “A,” the control logic 221 and availability module 229 may not register the existence of an updated content item if an updated content item occurs for friends of the user on social network “B.” In other words, the control logic 221 and availability module 229 may filter updated content items such that the control logic 221 and availability module 229 may send a signal for availability of updated content items only where detected updated content items are meaningful to a user. The interactions of the control logic 221, interest module 223, parameter module 225, and/or context module 227 may inform the control logic 221 and availability module 229 of what is meaningful to a particular user.

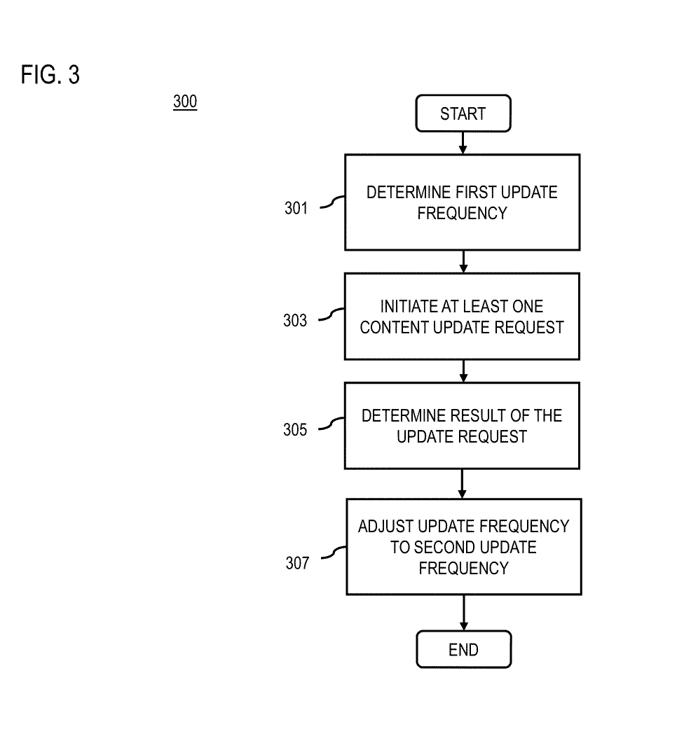

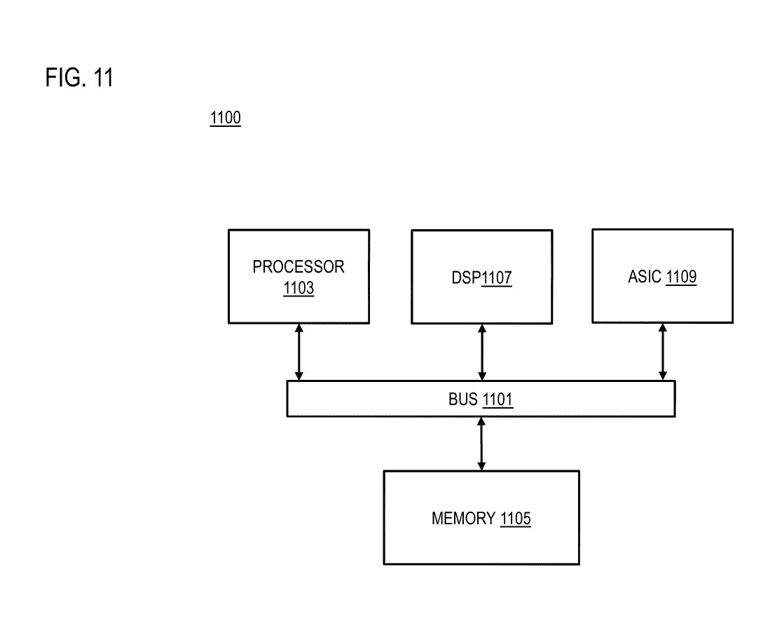

FIG. 3 is a flowchart of a process for adjusting the frequency at which a user receives updates, according to one embodiment. In one embodiment, the control logic 201 performs the process 300 and is implemented in, for instance, a chip set including a processor and a memory as shown in FIG. 11. In step 301 and step 303, the control logic 201 may cause, at least in part, an initiation of at least one content update request based, at least on in part, on a first update frequency. Then, the control logic 201 may determine at least one result of the at least one content update request for step 305. In step 307, the control logic 201 may cause, at least in part, an adjustment of the first update frequency to a second update frequency based, at least in part, on the at least one result. In one embodiment, the control logic 201 may determine one or more updated content items, wherein the one or more updated content items include one or more comments, one or more postings, one or more notes, one or more sharing actions, or a combination thereof in relation to shared content and wherein the one or more adjustments include extending the time interval between content updates, shortening the time interval, or a combination thereof.

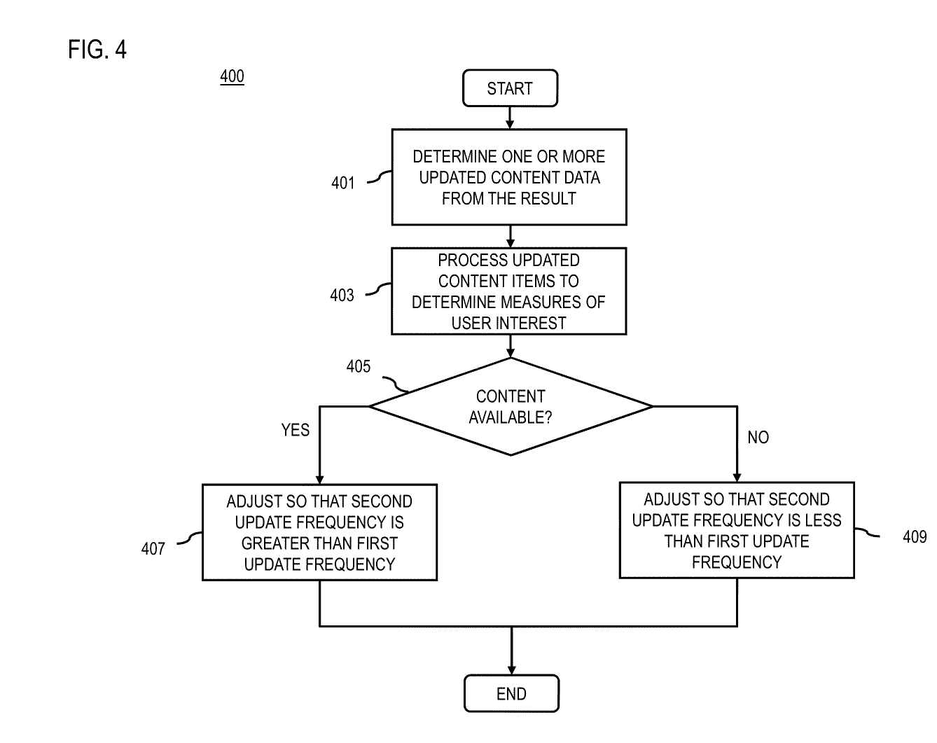

FIG. 4 is a flowchart of a process for determining a second update frequency, according to one embodiment. In one embodiment, the control logic 201 performs the process 400 and is implemented in, for instance, a chip set including a processor and a memory as shown in FIG. 11. In step 401, the control logic 201 may determine that the at least one result indicates, at least in part, that at least one content update is available. For instance, the control logic 201 may take step 401 wherein the at least one result indicates, at least in part, one or more updated content data and the control logic 201 processes and/or facilitates a processing of the one or more content items to determine one or more measures of user interest associated with the one or more updated content items. The measures of user interest may inform the control logic 201 in assessing whether at least one content update is available. For instance, a content update may exist, but it may be on a topic that a user has no interest in. In this case, the control logic 201 may determine that a no content update is available since the only content update is an update that a user would find irrelevant. Therefore, step 405 may involve the control logic 201 assessing whether or not at least one content update is available. If at least one content update is available, the control logic 201 may perform step 407 of determining the adjustment so that the second update frequency is greater than the first update frequency. If at least one content update is not available, the control logic 201 may perform step 409 of determining the adjustment so that the second update frequency is less than the first update frequency. In a further embodiment, the control logic 201 may determine the second update frequency based, at least in part, on the one or more measures of user interest.

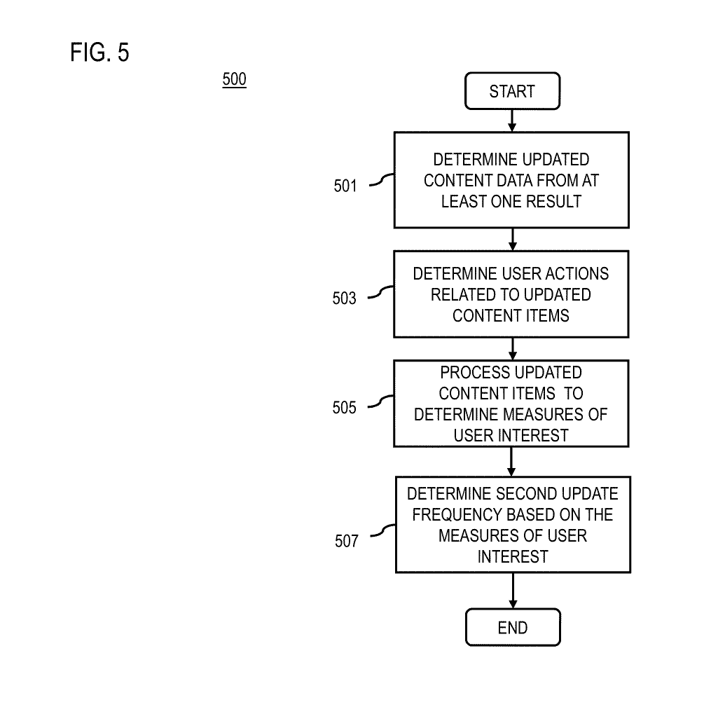

FIG. 5 is a flowchart of a process for determining measures of user interest, according to one embodiment. In one embodiment, the control logic 201 performs the process 500 and is implemented in, for instance, a chip set including a processor and a memory as shown in FIG. 11. In step 501 and 503, the control logic 201 may determine updated content items from at least one result and determine user actions in relation to the one or more updated content items. This may mean for the control logic 201 to continually monitor certain types of updated content items for new information related to those updated content items. Then for step 505, the control logic 201 may process updated content items to determine measures of user interest wherein the one or more measures of user interest are based, at least in part, on the user actions in relation to the one or more updated content items. For instance, the control logic 201 may constantly create and/or evaluate new and existing measures of user interest, in addition to evaluating the levels of user interest itself. For step 507, the control logic 201 may determine the second update frequency based, at least in part, on the measures of user interest determined from the updated content items and user actions to the content items.

In a further embodiment, the process 500 may include the control logic 201 determining sensor information associated with one or more devices. Then, the control logic 201 may cause, at least in part, the adjustment based, at least in part, on the sensor information, wherein the sensor information includes contextual sensor information. For instance, control logic 201 may cause update frequencies to be adjusted based on user location or setting. In one embodiment, the control logic 201 may further cause, at least in part, a presentation of a graphical representation for the first update frequency, the second update frequency, or a combination thereof and determine a prompt to override the first update frequency based, at least in part, on one or more user interactions with the graphical representation of the first update frequency.

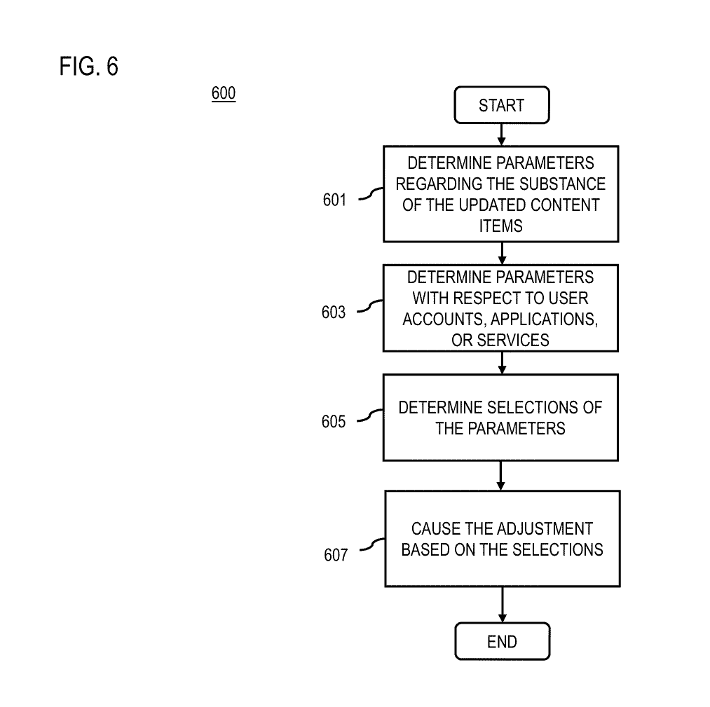

FIG. 6 is a flowchart of a process for determining parameters specific to sources of updated content items, according to one embodiment. In one embodiment, the control logic 201 performs the process 600 and is implemented in, for instance, a chip set including a processor and a memory as shown in FIG. 11. For step 601, the control logic 201 may determine one or more parameters regarding the substance of the one or more updated content items. For instance, the control logic 201 may determine the one or more parameters with respect to one or more user accounts, one or more applications, one or more services, or a combination thereof for step 603. In addition, the control logic 201 may determine one or more selections of the one or more parameters (step 605). Then, the control logic 201 may determine the first update frequency, the second update frequency, or a combination thereof based, at least in part on the one or more selections. In other words, the control logic 201 may cause, at least in part, the adjustment respective of the one or more user accounts, one or more applications, one or more services, or a combination thereof. This way, users may have finer control regarding the content they receive from various services.

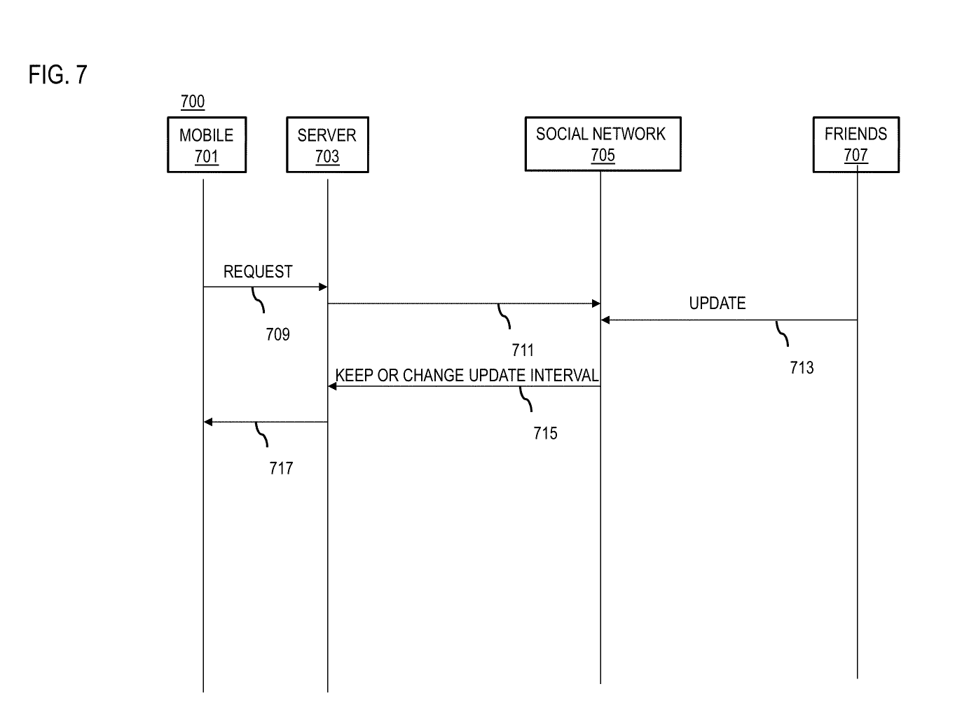

FIG. 7 shows a signal diagram 700 of the process of FIG. 3, according to one embodiment. In one embodiment, a mobile device 701 may be in communication with a server 703. The server 703 may poll for updates within a social network 705, for example, updated content items generated by users connected with the mobile device 701. Users connected with the mobile device 701 may be represented, for instance, by friends 707. In one embodiment, the mobile device 701 may perform step 709 of requesting at least one content update from the server 703. For example, the mobile device 701 may initiate a request for data. In one embodiment, the server 703 may then contact social network 705 in step 711 to determine whether content updates are available. In another embodiment, mobile device 701 may directly contact social network 705 rather than step 711 taking place between the server 703 and social network 705. The social network 705 may observe that friends 707, indeed, have generated updated content items via update 713. Then, social network 705 may inform server 703 of the update 713 and initiate step 715 prompting server 703 to keep, change, or update the time interval between updates (meaning, the update frequency). The server 703 may then change the update frequency and present mobile device 701 with updates according to the frequency, via step 717.

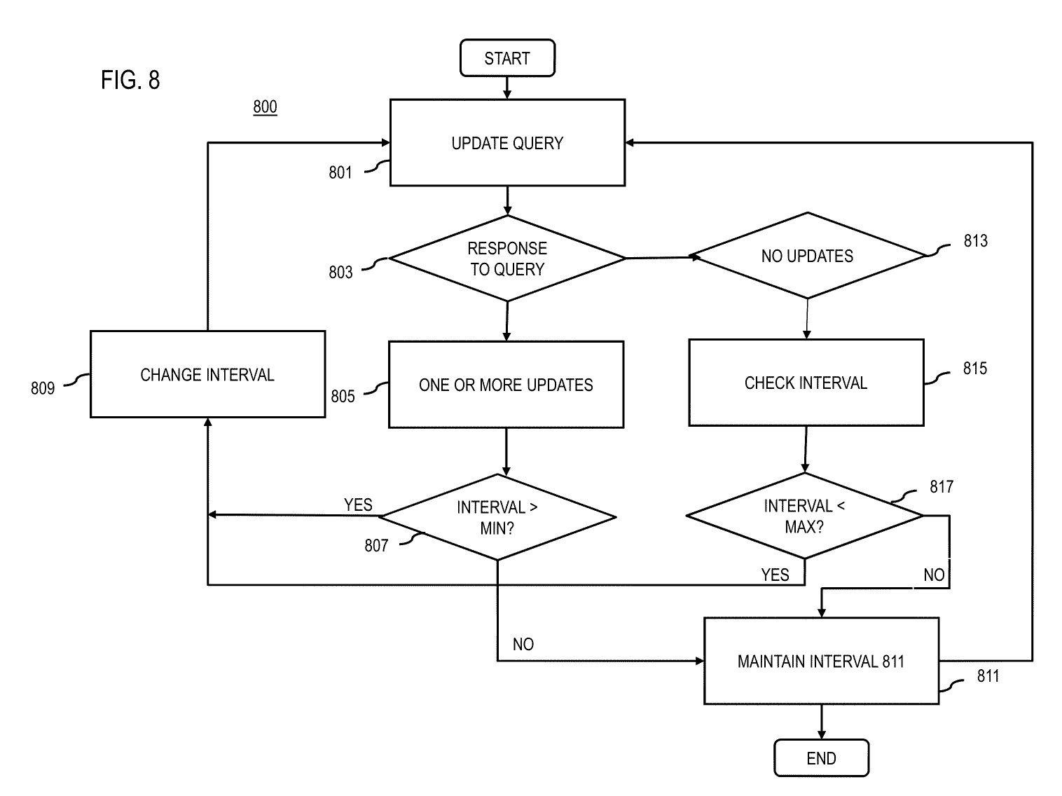

FIG. 8 shows a flowchart of a process 800 for adjusting the update frequency, according to one embodiment. For instance, a server may execute step 801 of querying for updates. If there is a response 803 to the query, the server may determine that an update is available. Then, the server may determine the quantity of updates in step 805. In one embodiment, the server may then determine how much time has passed since the last update. For instance, with step 807, the server may determine that the more than a minimum amount of time has passed since the last update. In this case, the minimum amount of time may be the lowest threshold timing where a user may not want to receive updates more often than that minimum amount of time. If more than the minimum time has passed, the server may execute step 809 of changing the update frequency. If not, the server may execute step 811 of maintaining the update frequency (or update interval). Alternately, if there are no updates 813 in response to the query for updates in step 801, the server may reevaluate the update frequency with step 815. For instance, the server may see with step 817, if the time interval dictated by update frequency has passed yet. If not, the server may maintain the update frequency (step 811). If the time interval has already been exceed and there have been no updates, the server may adjust the update frequency (step 809).

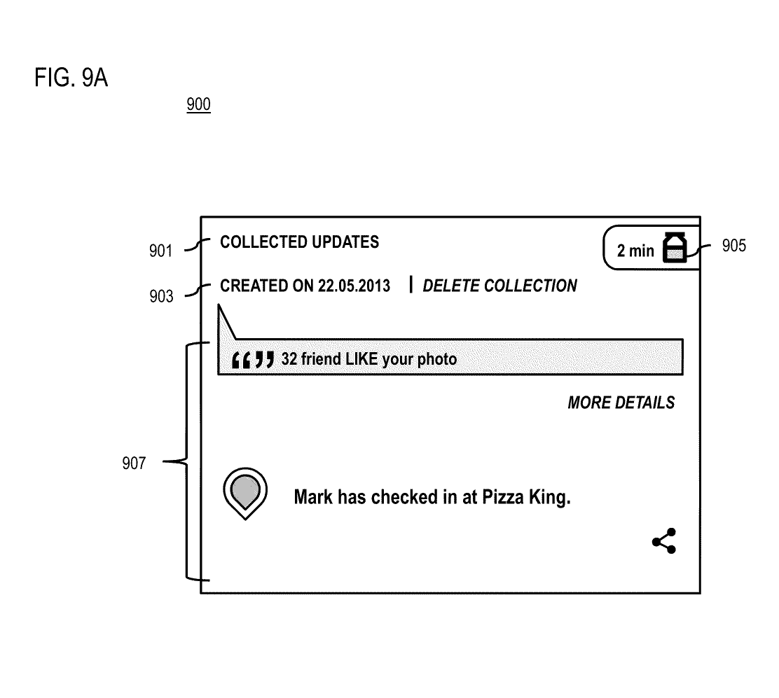

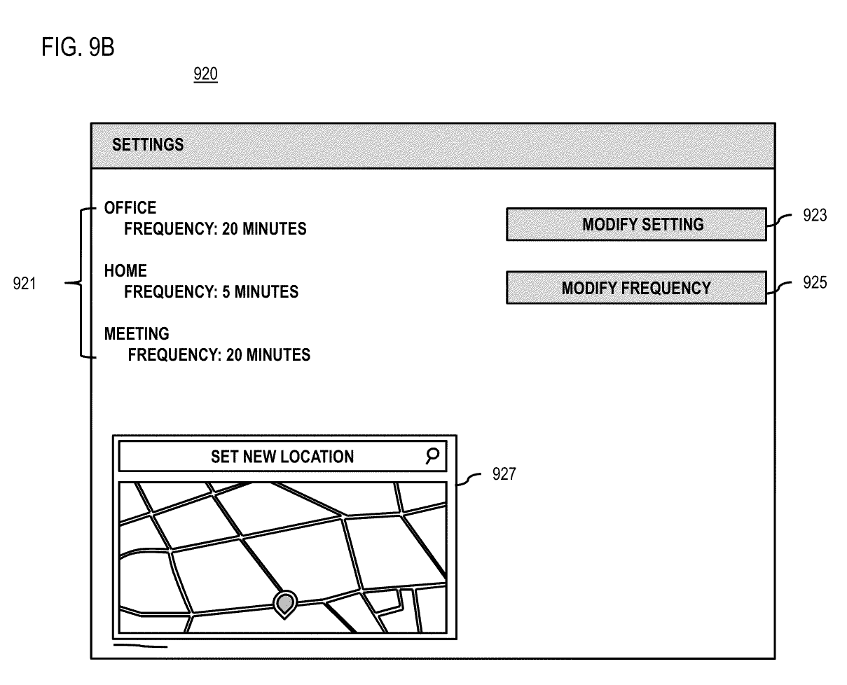

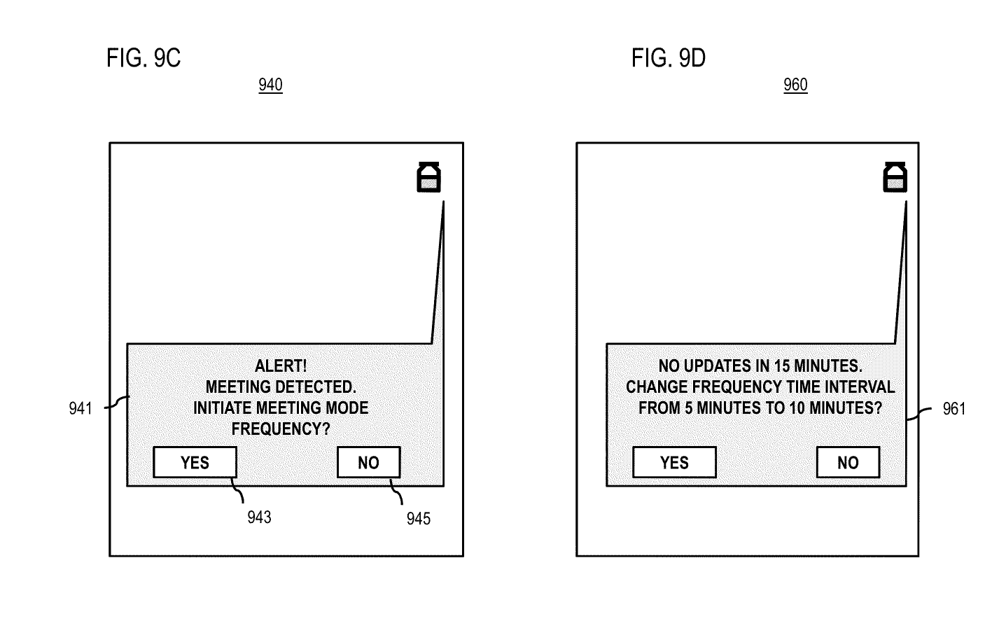

FIG. 9A is a diagram of a user interface 900 utilized in the processes of FIG. 3, according to various embodiments. In one embodiment, user interface 900 may include a presentation 901 of collected updated content items. In one embodiment, user interface 900 may further include the timing 903 when the presentation 901 was generated. For instance, timing 903 may give insight into how much time is remaining before the next update, given the update frequency. In one embodiment, user interface 900 may include a counter and/or progress bar 905 showing the timing and/or time remaining before the next update. Updates 907 may then be listed in user interface 900. Updates 907 may be repopulated or replaced at the start of each update time interval.

FIG. 9B is a diagram of a user interface 920 utilized in the processes of FIG. 6, according to various embodiments. In one embodiment, user interface 920 may include a presentation 921 of update frequencies specific to various locations and/or scenarios. As previously discussed, update frequencies may be particular to locations, scenarios, user accounts, applications, services, or a combination thereof. In one embodiment, user interface 920 may first include presentation 921 to show settings that a user may already have in place. In one embodiment, presentation 921 may be an initial user interface 910, showing default update frequencies for when a user may enter his settings the first time. In another embodiment, presentation 921 may be the most up-to-date update frequencies. In one embodiment, user interface 920 may further include setting button 923 for users to modify the settings that are part of presentation 921. For example, setting button 923 may include a drop-down with selections to add, delete, and/or revise a setting. In another embodiment, user interface 920 may include frequency button 925 where a user may manually set an update frequency. For example, the frequency button 925 may lead to a drop-down list for a user to select which setting to change. For the listing in presentation 921, the drop-down list may include the locations/scenarios of “office”, “home”, and “meeting.” In another scenario, however, the frequency button 925 may include a drop-down list that allows for whatever settings are listed in presentation 921, including user accounts, applications, and/or services. In one embodiment, user interface 920 may further include a location function 927, where a user may set update frequencies to be linked with physical locations. For instance, “office” update frequency may initiate automatically upon detection that a device is in a location associated with “office.”

FIG. 9C is a diagram of a user interface 940 to alert a user to changes in update frequency, according to various embodiments. In one embodiment, user interface 940 may include an alert 941, informing a user when a certain mode of update frequency may be applied. For example, a user entering a meeting scenario (as detected by synchronization between system 100 and the calendar functionality of a UE 101, for instance), may encounter alert 941. Alert 941 in this scenario may inform the user that update frequencies for “meeting” mode may apply and request approval. In one embodiment, alert 941 may include the update frequency in terms of timing. For example, alert 941 may indicate to the user that a meeting setting entails an update frequency of updates arriving no more frequently than 20 minutes. In another embodiment, alert 941 may simply indicate the availability of a different update frequency. In one embodiment, user interaction may be necessary to change from one setting to another. For instance, even if a user is no longer in a meeting as dictated by calendar scheduling, update frequency may remain in the meeting update frequency until a user indicates otherwise. This way, a user is not disturbed more often while he is a meeting that extends beyond the scheduled time allotment. In one embodiment, alert 941 may include “yes” button 943 and “no” button 945 for a user to verify whether to apply a certain setting.

FIG. 9D is a diagram of a user interface 960 to alert a user to changes in update frequency, according to various embodiments. In one embodiment, system 100 may include notification 961 to request user approval for changes in update frequency. For instance, notification 961 may inform a user that updates have not repopulated in the usual update frequency because no updates are available. In other words, notification 961 may indicate to a user that updates have not come up past a time interval involved in the update frequency. In one embodiment, notification 961 may further request user interaction to approve of changes to update frequencies.

The processes described herein for adjusting the frequency at which a user receives updates may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

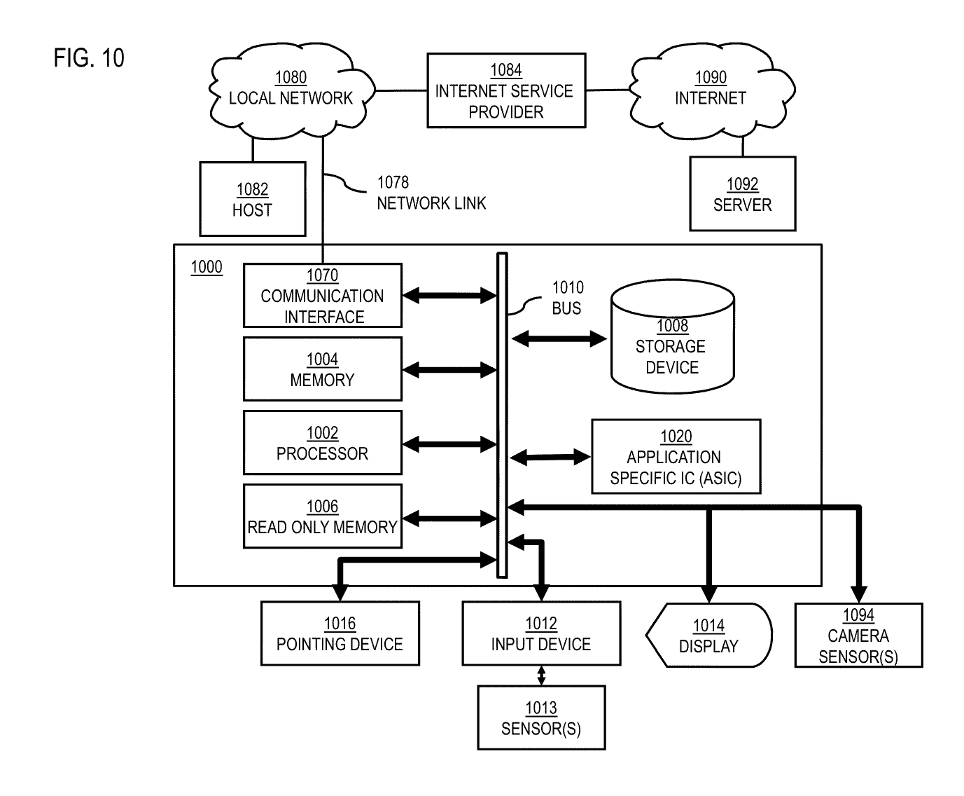

FIG. 10 illustrates a computer system 1000 upon which an embodiment of the invention may be implemented. Although computer system 1000 is depicted with respect to a particular device or equipment, it is contemplated that other devices or equipment (e.g., network elements, servers, etc.) within FIG. 10 can deploy the illustrated hardware and components of system 1000. Computer system 1000 is programmed (e.g., via computer program code or instructions) to adjust the frequency at which a user receives updates as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps of adjusting the frequency at which a user receives updates.

A bus 1010 includes one or more parallel conductors of information so that information is transferred quickly among devices coupled to the bus 1010. One or more processors 1002 for processing information are coupled with the bus 1010.

A processor (or multiple processors) 1002 performs a set of operations on information as specified by computer program code related to adjusting the frequency at which a user receives updates. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1000 also includes a memory 1004 coupled to bus 1010. The memory 1004, such as a random access memory (RAM) or any other dynamic storage device, stores information including processor instructions for adjusting the frequency at which a user receives updates. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or any other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for adjusting the frequency at which a user receives updates, is provided to the bus 1010 for use by the processor from an external input device 1012, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT), a liquid crystal display (LCD), a light emitting diode (LED) display, an organic LED (OLED) display, a plasma screen, or a printer for presenting text or images, and a pointing device 1016, such as a mouse, a trackball, cursor direction keys, or a motion sensor, for controlling a position of a small cursor image presented on the display 1014 and issuing commands associated with graphical elements presented on the display 1014, and one or more camera sensors 1094 for capturing, recording and causing to store one or more still and/or moving images (e.g., videos, movies, etc.) which also may comprise audio recordings. In some embodiments, for example, in embodiments in which the computer system 1000 performs all functions automatically without human input, one or more of external input device 1012, display device 1014 and pointing device 1016 may be omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of ASICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 105 for adjusting the frequency at which a user receives updates to the UE 101.

The term “computer-readable medium” as used herein refers to any medium that participates in providing information to processor 1002, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1008. Volatile media include, for example, dynamic memory 1004. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1020.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system 1000 can be deployed in various configurations within other computer systems, e.g., host 1082 and server 1092.

At least some embodiments of the invention are related to the use of computer system 1000 for implementing some or all of the techniques described herein. According to one embodiment of the invention, those techniques are performed by computer system 1000 in response to processor 1002 executing one or more sequences of one or more processor instructions contained in memory 1004. Such instructions, also called computer instructions, software and program code, may be read into memory 1004 from another computer-readable medium such as storage device 1008 or network link 1078. Execution of the sequences of instructions contained in memory 1004 causes processor 1002 to perform one or more of the method steps described herein. In alternative embodiments, hardware, such as ASIC 1020, may be used in place of or in combination with software to implement the invention. Thus, embodiments of the invention are not limited to any specific combination of hardware and software, unless otherwise explicitly stated herein.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server host 1092 transmits program code for a particular application, requested by a message sent from computer 1000, through Internet 1090, ISP equipment 1084, local network 1080 and communications interface 1070. The received code may be executed by processor 1002 as it is received, or may be stored in memory 1004 or in storage device 1008 or any other non-volatile storage for later execution, or both. In this manner, computer system 1000 may obtain application program code in the form of signals on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

FIG. 11 illustrates a chip set or chip 1100 upon which an embodiment of the invention may be implemented. Chip set 1100 is programmed to adjust the frequency at which a user receives updates as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of providing user interface navigation information associated with the availability of functions. Chip set or chip 1100, or a portion thereof, constitutes a means for performing one or more steps of adjusting the frequency at which a user receives updates.

In one embodiment, the chip set or chip 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1100 includes merely one or more processors and some software and/or firmware supporting and/or relating to and/or for the one or more processors.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to adjust the frequency at which a user receives updates. The memory 1105 also stores the data associated with or generated by the execution of the inventive steps.

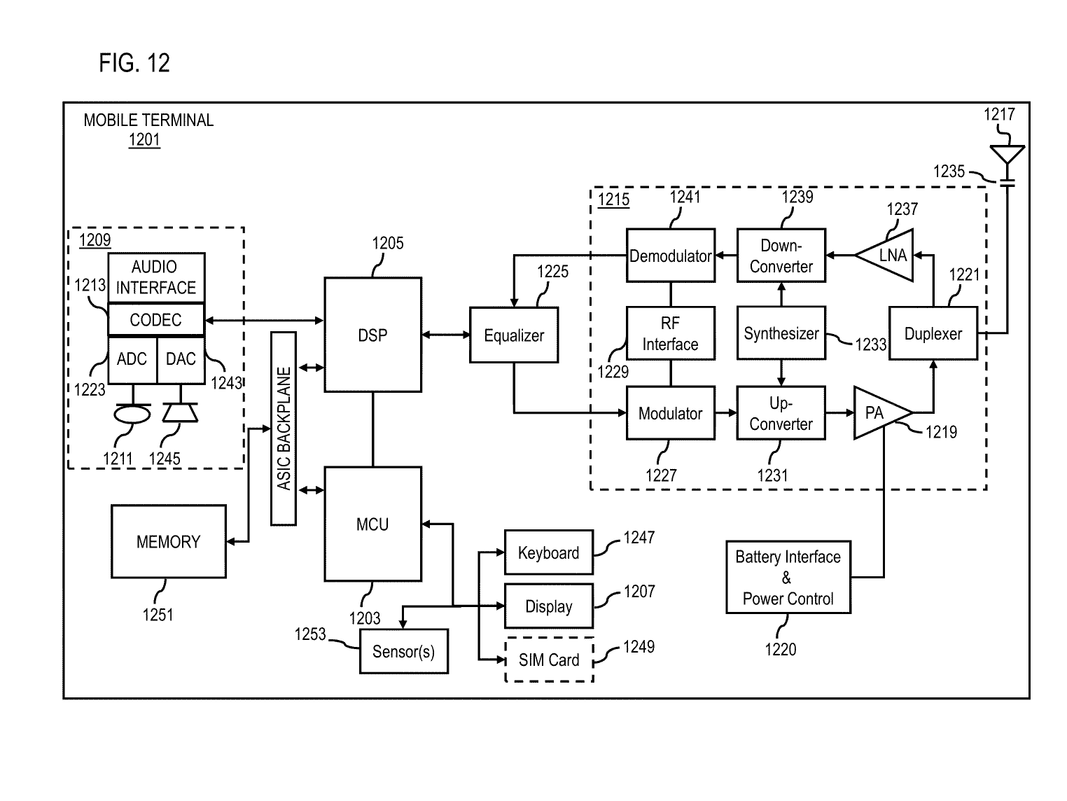

FIG. 12 is a diagram of exemplary components of a mobile terminal (e.g., handset) for communications, which is capable of operating in the system of FIG. 1, according to one embodiment. In some embodiments, mobile terminal 1201, or a portion thereof, constitutes a means for performing one or more steps of adjusting the frequency at which a user receives updates. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps of adjusting the frequency at which a user receives updates. The display 1207 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203 which can be implemented as a Central Processing Unit (CPU).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile terminal 1201 to adjust the frequency at which a user receives updates. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

Further, one or more camera sensors 1253 may be incorporated onto the mobile station 1201 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
an initiation of at least one content update request based, at least in part, on a first update frequency; and
at least one determination of at least one result of the at least one content update request; and
an adjustment of the first update frequency to a second update frequency based, at least in part, on the at least one result.

2. A method of claim 1, wherein the at least one user interface element includes, at least in part, computer code data, the method further comprising:
at least one determination that the at least one result indicates, at least in part, that at least one content update is available; and
at least one determination of the adjustment so that the second update frequency is greater than the first update frequency.

3. A method of claim 2, wherein the (1) data and/or (2) information and/or (3) at least one signal are further based, at least in part, on the following:
at least one determination that the at least one result indicates, at least in part, that at least one content update is not available; and
at least one determination of the adjustment so that the second update frequency is less than the first update frequency.

4. A method of claim 1, the at least one result indicates, at least in part, one or more updated content items, and wherein the (1) data and/or (2) information and/or (3) at least one signal are further based, at least in part, on the following:
a processing and/or a facilitating a processing of the one or more updated content items to determine one or more measures of user interest associated with the one or more updated content items; and
at least one determination of the second update frequency based, at least in part, on the one or more measures of user interest.

5. A method of claim 1, wherein the (1) data and/or (2) information and/or (3) at least one signal are further based, at least in part, on the following:
at least one determination of user actions in relation to the one or more updated content items,
wherein the one or more measures of user interest are based, at least in part, on the user actions in relation to the one or more updated content items.

6. A method of claim 1, wherein the (1) data and/or (2) information and/or (3) at least one signal are further based, at least in part, on the following:
at least one determination of one or more parameters regarding the substance of the one or more updated content data; and
at least one determination of one or more selections of the one or more parameters,
at least one determination of the first update frequency, the second update frequency, or a combination thereof based, at least in part, on the one or more selections

7. A method of claim 6, wherein the (1) data and/or (2) information and/or (3) at least one signal are further based, at least in part, on the following:
at least one determination of the one or more parameters with respect to one or more user accounts, one or more applications, one or more services, or a combination thereof; and
causing, at least in part, the adjustment respective of the one or more user accounts, one or more applications, one or more services, or a combination thereof.

8. A method of claim 1, wherein the (1) data and/or (2) information and/or (3) at least one signal are further based, at least in part, on the following:
at least one determination of sensor information associated with one or more devices; and
a causing, at least in part, of the adjustment based, at least in part, on the sensor information,
wherein the sensor information includes contextual sensor information.

9. A method of claim 1, wherein the (1) data and/or (2) information and/or (3) at least one signal are further based, at least in part, on the following:
a presentation of a graphical representation of the first update frequency, the second update frequency, or a combination thereof; and
at least one determination of a prompt to override the first update frequency based, at least in part, on one or more user interactions with the graphical representation of the first update frequency.

10. A method of claim 1, wherein the (1) data and/or (2) information and/or (3) at least one signal are further based, at least in part, on the following:
at least one determination of one or more updated content items, wherein the one or more content items include one or more comments, one or more postings, one or more notes, one or more sharing actions, or a combination thereof in relation to shared content, and
wherein the one or more adjustments include extending the time interval, shortening the time interval, or a combination thereof.

11. An apparatus comprising:
at least one processor; and
at least one memory including computer program code for one or more programs,
the at least one memory and the computer program code configured to, with the at least one processor, cause the apparatus to perform at least the following,
cause, at least in part, an initiation of at least one content update request based, at least in part, on a first update frequency;
determine at least one result of the at least one content update request; and
cause, at least in part, an adjustment of the first update frequency to a second update frequency based, at least in part, on the at least one result.

12. An apparatus of claim 11, wherein the apparatus is further caused to:
determine that the at least one result indicates, at least in part, that at least one content update is available; and
determine the adjustment so that the second update frequency is greater than the first update frequency.

13. An apparatus of claim 11, wherein the apparatus is further caused to:
determine that the at least one result indicates, at least in part, that at least one content update is not available; and
determine the adjustment so that the second update frequency is less than the first update frequency.

14. An apparatus of claim 11, wherein the at least one result indicates, at least in part, one or more updated content items and the apparatus is further caused to:
process and/or facilitate a processing of the one or more updated content items to determine one or more measures of user interest associated with the one or more updated content items; and
determine the second update frequency based, at least in part, on the one or more measures of user interest.

15. An apparatus of claim 11, wherein the apparatus is further caused to:
determine user actions in relation to the one or more updated content items,
wherein the one or more measures of user interest are based, at least in part, on the user actions in relation to the one or more updated content items.

16. An apparatus of claim 11, wherein the apparatus is further caused to:
determine one or more parameters regarding the substance of the one or more updated content data; and
determine one or more selections of the one or more parameters,
determine the first update frequency, the second update frequency, or a combination thereof based, at least in part, on the one or more selections.

17. An apparatus of claim 16, wherein the apparatus is further caused to:
determine the one or more parameters with respect to one or more user accounts, one or more applications, one or more services, or a combination thereof; and
cause, at least in part, the adjustment respective of the one or more user accounts, one or more applications, one or more services, or a combination thereof.

18. An apparatus of claim 11, wherein the apparatus is further caused to:
determine sensor information associated with one or more devices; and
cause, at least in part, the adjustment based, at least in part, on the sensor information,
wherein the sensor information includes contextual sensor information.

19. An apparatus of claim 11, wherein the apparatus is further caused to:
cause, at least in part, a presentation of a graphical representation of the first update frequency, the second update frequency, or a combination thereof; and
determine a prompt to override the first update frequency based, at least in part, on one or more user interactions with the graphical representation of the first update frequency.

20. An apparatus of claim 11, wherein the apparatus is further caused to:
determine one or more updated content items, wherein the one or more content items include one or more comments, one or more postings, one or more notes, one or more sharing actions, or a combination thereof in relation to shared content, and
wherein the one or more adjustments include extending the time interval, shortening the time interval, or a combination thereof.

21.-48. (canceled)
